(19) United States
(12) Patent Application Publication
(10) Pub. No.: US 2010/0257384 A1
(43) Pub. Date: Oct. 7, 2010

(54) Device and Method for Remote Wake-Up

(75) Inventors: Wu-Nan Tsai, Taipei City (TW); Jun Wang, Taipei City (TW); Jen-Li Wang, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: COMPAL ELECTRONICS, INC., Taipei City (TW)

(21) Appl. No.: 12/573,984

(22) Filed: Oct. 6, 2009

(30) Foreign Application Priority Data
Apr. 2, 2009 (TW) 98111046

(51) Int. Cl. G06F 1/26

(52) U.S. Cl. 713/310

(57) ABSTRACT

A device and a method for remote wake-up are provided. The device for remote wake-up includes a processing element and a network module, wherein the network module includes a connection module, a receiving module, a determination module, and a wake-up module. In the method for remote wake-up, a local host firstly logins a network server. Then, the local host maintains connection with the network server after entering a suspend mode, and thereby the network position of the local host is determined. Thereafter, the local host receives a network packet and determines if the network packet is a network wake-up packet transmitted from a remote client and through the network server and. When the network packet is a network wake-up packet, the local host returns to normal operation mode.

### RELATED APPLICATIONS

This application claims priority to Taiwan Application Serial Number 98111046, filed Apr. 2, 2009, which is herein incorporated by reference.

### FIELD OF THE INVENTION

This invention relates to a method and a device for remote wake-up, and more particularly, to a method and a device adapted to electronic devices.

### BACKGROUND OF THE INVENTION

In traditional Wake-on-Lan technology, a Wakeup-Link mainboard for a local host, a specific software program, an internet protocol (IP) address of the local host, a media access control (MAC) address, and setting a network wakeup setting of the local host to an enable state are required to perform a wake-up function of the local host.

When the local host is shut down or in a suspend mode, the net interface card (NIC) and the mainboard thereof are still supplied with little power. The little power enables the net interface card to keep in a minimum performance, so that the net interface card can receive a net broadcast message from external devices, and interpret and detect the content of the broadcast message. When a specific message called a magic packet is discovered from the net broadcast message, the content of the packet is analyzed.

Each time when the magic packet is received, an information content includes six continuous FF is firstly presented in the magic packet. It means FF FF FF FF FF FF. After the six FF are presented, an information about the media access control address is presented. Sometimes, a 4-bit secret code or a 6-bit secrete code is also presented after the six FF. When the content of the magic packet is detected, interpreted, and analyzed, and when the media access control address and the secret code of the local host are matched with that of the content of the magic packet, a process for waking up or turning on the local host is started.

The foregoing wake-up method must performed with specific hardware devices, software programs, a dress of a local host to be waked up known in advance, and presetting for the specific hardware devices. Thus, no matter for the manufacturers or the users of the local sever, the requirements for performing the foregoing wake-up method perplex them to some extent and increases the cost to perform the foregoing wake-up method to some extent. Therefore, how to develop a remote wake-up method can be generally applied to various electronic devices and performed without installing specific software programs and increasing hardware cost is greatly expected by the users.

### SUMMARY OF THE INVENTION

An aspect of the present invention is to provide a method and a device for remote wake-up. The remote wake-up method and device can perform remote wake-up function for an electronic device with littlie modification on a network module in the electronic device, and also perform the remote wake-up function without installing specific software and increasing cost of hardware. The remote wake-up method and device use a popular IP based software program to perform remote wake-up function, and can be applied to various electronic devices.

According to an embodiment of the present invention, a remote wake-up method adapted for electronic devices is provided. The remote wake-up method includes the following steps. At first, a local host logins a network server. After entering a suspend mode, the local host maintains connection with the network server, and thereby the network position of the local host is determined. Then, the local host receives a network packet and determines if the network packet is a network wake-up packet transmitted from a remote client and through the network server and. When the network packet is a network wake-up packet, the local host returns to normal operation mode.

According to another embodiment of the present invention, a device for remote wake-up is provided. The remote wake-up device includes a processing element and a network module, wherein the network module includes a connection module, a receiving module, a determination module, and a wake-up module. The connection module is configured for logging in a network server and connecting the local host with the network server after the local host enters a suspend mode. The receiving module is configured for receiving a network packet. The determination module is configured for determining if the network packet is a network wake-up packet transmitted through the network server from a remote client. The wake-up module is configured for waking the local host up to make the local host return to a normal operation mode when the network packet received is a network wake-up packet.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a flow chart showing a method for remote wake-up according to an embodiment of the present invention; and

FIG. 2 is a diagram showing the structure of a local host having remote wake-up function according to another embodiment of the present invention.

### DETAILED DESCRIPTION OF THE PREFERRED EMBODIMENT

The wake-up method of the present invention is adapted for various electronic devices. Without installing specific software and increasing cost of hardware, the purpose of the present invention can be reached. When the electronic device enters a suspend mode, a popular software program based on internet protocol is used to accomplish the remote wake-up function, and extend applications after the electronic device wakes. The electronic device adopting the wake-up method can be a mobile internet device (MID), a netbook, notebook, or a local host having operation system. It is understood that in the embodiments of the present invention, all the steps or parts of the steps may be performed at the same time, or the order of each of the steps of the wake-up method can be modified depends on the actual demand, unless the order of each steps is particularly pointed out.

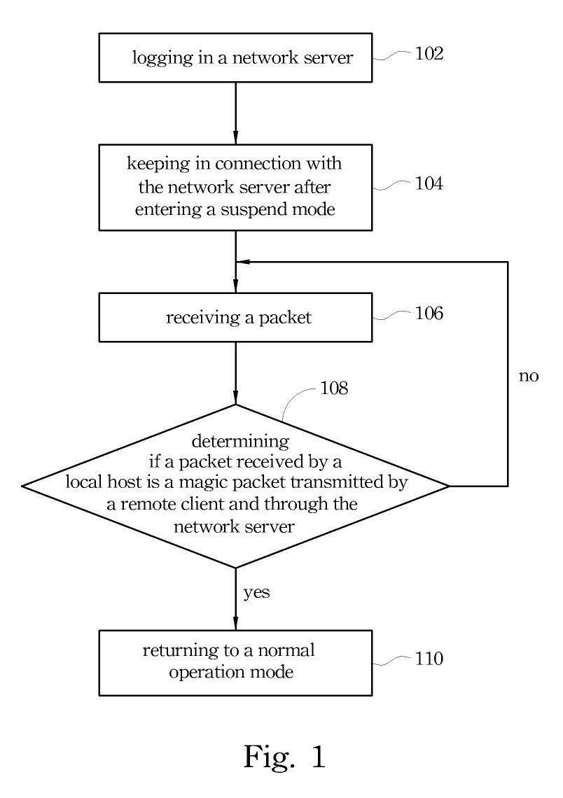

Refer to FIG. 1. FIG. 1 is a flow chart showing a method for remote wake-up according to an embodiment of the present invention. At first, as shown by step 102, a local host logins a network server. The method to login the network server is to transmit a login message from the local host to the network server to inform the network server that the local host is going to login, and then send back an allow message from the network server to the local host to allow the local host to login. The purpose of the step 102 is to check the network address of the local host, and the network address is for a remote wake-up action performed by a remote client. Thus, it is not necessary to know the internet protocol (IP) address and the media access control (MAC) address in advance.

For example, in an embodiment, a user uses an instant message software program MSN to input his account and password to login a MSN instant message server. Thus, the connection between the local host and the instant message server can be maintained. The network server mentioned in the present invention is generally referred to a network server using a IP based software to make network connection and work. The foregoing IP based software can be software such as MSN, skype, or netmeeting, but the present invention is not limited to therein.

Thereafter, as shown by step 104, when the step 102 is performed, the connection between the local host and the instant message server can be maintained after the local host enters a suspend mode. In a prior art, when a local host enters the suspend mode, power of a net interface card (NIC) of the local host is cut for the purpose of power saving. The action for power saving would make the local host logout the network server, thus the network address of the local host cannot be determined for the remote wake-up action performed by a remote client. Therefore, the setting of a network module of the local host is modified to enable the local host to maintain the connection between the local host and the instant message server after the local host enters the suspend mode. The local host transmits connection packets to the network server, or regularly transmits connection packets to the network server, so that the network server considers that the local host is in a normal operation mode but not the suspend mode. Therefore, after the local host enters the suspend mode, the connection between the local host and the instant message server can be maintained.

In an embodiment, a MSN instant message server is illustrated as a network server of the present invention. Traditionally, when a local host enters a suspend mode, the local host would automatically logout. However, the network interface module of the local host is modified in the present invention, so that the local host would not automatically logout after entering the suspend mode. Thus, The connection between the local host and the MSN instant message server is maintained. The network address of the local host can be determined via the connection between the local host and the MSN instant message server.

In the step 106, network packets are received. When the local host is in the suspend mode, the NIC is still provided with little power to maintain basic operation performance. Therefore, the local host can continuously receive packets having various communication protocols from the network.

The step 108 determines if the network packet is a network wake-up packet transmitted from the remote client and through the network server. The wake-up method can perform determination on the network packet after the step 106 is performed to receive the network packet. It is determined that if the network packet received in the step 106 is a network wake-up packet transmitted from the remote client and through the network server by modifying the setting of the network module of the local host. When the determining result is true, the local host is waked up to returned to a normal operation mode. When the determining result is false, the remote wake-up method returns to the step 106 to continuously receive the network packets.

For example, in an embodiment, the parameters of the network module is changed to enable the network module to determine if the packet format of the network packet presently received matches the format of the MSN instant message packet transmitted through the MSN instant message server.

In the end, the step 110 is performed to enable the local host to return to the normal operation mode. When the step 108 determines the network packet received is the network wake-up packet, the local host returns to the normal operation mode. After returning to the normal operation mode, the local host stops determining if the network packet received is the network wake-up packet. It is no longer required to determine if the network packet received is the network wake-up packet.

In an embodiment, when the network module determines the network packet received matches the format of the MSN instant message packet, the local host is waked up to enable the local host to return to the normal operation mode. Then, the network module stops determining if the network packet received matches the format of the MSN instant message packet, and transmits and receives network packets normally.

It is understood that the foregoing embodiments are not use to limit the present invention in using MSN instant message software. The present invention can be applied on MSN, Skype, Netmeeting, and various software based on IP.

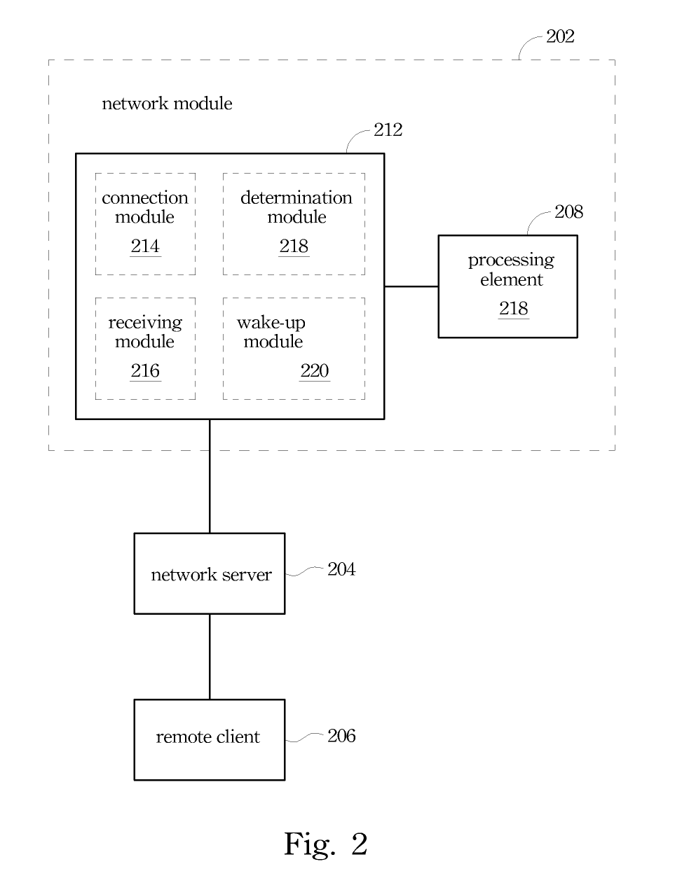

Refer to FIG. 2. FIG. 2 is a diagram showing the structure of a local host 202 having remote wake-up function according to another embodiment of the present invention. The local host 202 includes a processing element 208 and network module 212, wherein the network module 212 includes a connection module 214, a receiving module 216, a determination module 218 and a wake-up module 220.

The connection module 214 is used to login a network server 204. The local host 202 transmits a login message to the network server 204 to inform the network server 204 that the local host 202 is going to perform a login action. Then the network server 204 sends back an allow message to the local host 202 to allow the local host 202 to login. By this method, the network address of the local host can be determined. Thus, it is not necessary to know the internet protocol (IP) address and the media access control (MAC) address in advance for a remote wake-up action performed by a remote client 206. The network server 204 mentioned in the present invention is generally referred to a network server using a IP based software to make network connection and work. The foregoing IP based software can be software such as MSN, skype, netmeeting, or the like, but the present invention is not limited to therein.

The connection module 214 transmits connection packets to the network server 204 or regularly transmits connection packets to the network server 204 to maintain the connection between the network server 204 and the local server 202 after the local server 202 enters a suspend mode. This action can make the network server 204 consider the local host 202 is in a normal operation mode but not the suspend mode. The network position of the local host 202 can be determined via maintaining the connection for the remote wake-up performed by the remote client 206.

For example, in a specific embodiment, when the network server of the present invention is a MSN instant message server, and the user inputs account and password to login the MSN instant message server 204, the connection between the local host 202 and the MSN instant message server 204 is maintained. In a prior art, after the local host 202 enters the suspend mode, power of a net interface card of the local host 202 is cut for the purpose of power saving. The action for power saving would make the local host 202 logout the network server, thus the network address of the local host 202 cannot be determined for the remote wake-up action performed by the remote client 206. Therefore, the setting of the connection module 214 of the local host 202 is modified to enable the local host 202 to maintain the connection between the local host 202 and the instant message server 204 to prevent the local host 202 from automatically logging out after the local host 202 enters the suspend mode. Therefore, the modification made to the settings of the connection module 214 of the local host 202 enables the local host 202 to maintain the connection between the local host 202 and the instant message server 204. The modification made to the settings means modification to the connection function settings in the internal program codes of the network module 212. The network address of the local host 202 can be determined via the connection between the MSN instant communication server 204 and the local host 202.

The receiving module 216 is configured for receive all the packets comes form the internet. Although the local host 202 is already in the suspend mode, the NIC of the local host 202 is still provided with little power to enable the network module 212 to maintain basic operation performance, so that the network module 212 can continuously receive all the packets comes form the internet, and detect and analyze the content of the packets.

The determination module 218 determines if the network packet received is a network wake-up packet transmitted from the remote client 206 and through the network server 204. After the receiving module 216 receives the network packet, the determination module 218 performs the determining step. When the network packet received is the network wake-up packet, the wake-up module 220 is used to wake up the local host 202 to make the local host return to a normal operation mode, and the determination module 218 stops determining if the network packet received is the network wake-up packet. When the network packet received is not the network wake-up packet, the wake-up module 220 continuously receives the network packets.

The wake-up module 220 is configured for waking up the local host 202. When the determination module 218 determines that the network packet received is the network wake-up packet, the wake-up module 220 transmits a wake-up signal to the wake-up processing element 208 to wake the local host 202 up to enable the local host 202 to return to the normal operation mode. After the local host 202 returns to the normal operation mode, the determination module 218 stops determining if the network packet received is the network wake-up packet. It is no longer required to determine if the network packet received is the network wake-up packet.

The maximum difference between the prior art and this embodiment of the present invention is in that the modification to the settings of the connection module 214 and the determination module 218. The connection module 214 must maintain the connection between the local host 202 and the network server 204 after the local server 202 enters the suspend mode, so that the network address of the local host can be determined to help the following step performed for the wake-up function. The determination module 218 must determine if the network packet received is a network wake-up packet transmitted from the remote client 206 and through the network server 204, wherein the generally the network server 204 is generally referred to software based on IP to make network connection and work. The foregoing IP based software is software can transmit data via internet, such as MSN, Skype, Netmeeting, and the like, but present invention is not limited therein.

The most obvious modification made by the present invention to the prior art is the modification to the connection module 214 and the determination module 218. The modification to the connection module 214 and the determination module 218 means modification to the connection function settings in the internal program codes of the network module 212. The modification to the connection function enables the local host 202 to maintain the connection between the local host 202 and the network server 204, and thereby the network address of the local host 202 can be determined. The modification to the determination function enables the determination module 218 to determine if the format of the network packet received matches the format of the packet transmitted based on IP, but not to determine if the network packet received is the magic packet transmitted via broadcast.

As is understood by a person skilled in the art, the foregoing embodiments of the present invention are strengths of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A method for wake up a local host connected to a network server, wherein the method comprises:
setting the local host to enable the local host to be in connection with the network server when the local host is in a suspend mode;
determining if a network packet received by the local host is a network wake-up packet transmitted from a remote client and through the network server when the local host is in the suspend mode; and
making the local host return to a normal operation mode when the network packet received by the local host is a network wake-up packet.

2. The method of claim 1, further comprises transmitting a connection packet to the network server from the local host to enable the local host to be in connection with the network server when the local host is in the suspend mode.

3. The method of claim 1, further comprises regularly transmitting a connection packet to the network server from the local host to enable the local host to be in connection with the network server when the local host is in the suspend mode.

4. The method of claim 1, further comprises determining if a following network packet received by the local host is a network wake-up packet when the network packet is not a network wake-up packet transmitted from the remote client and through the network server.

5. The method of claim 1, further comprises stopping determining if a following network packet received by the local host is a network wake-up packet when the network packet is a network wake-up packet transmitted from the remote client and through the network server.

6. The method of claim 1, wherein the network server uses an internet protocol (IP) based software for internet connection.

7. The method of claim 6, wherein the IP based software is MSN, Skype, or Netmeeting software.

8. The method of claim 1, wherein the format of the network packet and the network wake-up packet is based on IP.

9. A device for wake up a local host, comprising:
a connection module, configured for connecting the local host with a network server, wherein the local host is set to be in connection with the network server when the local host is in a suspend mode;
a receiving module, configured for receiving a network packet transmitted to the local host;
a determination module, configured for determining if the network packet received by the local host is a network wake-up packet transmitted from the remote client and through the network server when the local host is in the suspend mode; and
a wake-up module, configured for waking the local host up to make the local host return to a normal operation mode.

10. The device of claim 9, wherein the connection module regularly transmits a connection packet to the network server to enable the local host to be in connection with the network server when the local host is in the suspend mode.

11. The device of claim 9, wherein the connection module transmits a connection packet to the network server to enable the local host to be in connection with the network server when the local host is in the suspend mode.

12. The device of claim 9, wherein the determination module determines if a following network packet received by the local host is a network wake-up packet when the network packet is not a network wake-up packet transmitted from the remote client and through the network server.

13. The device of claim 9, wherein the determination module stops determining if a following network packet received by the local host is a network wake-up packet when the network packet is a network wake-up packet transmitted from the remote client and through the network server.

14. The device of claim 9, wherein the network server uses an internet protocol (IP) based software for internet connection.

15. The device of claim 14, wherein the IP based software is MSN, Skype or Netmeeting software.

16. The device of claim 9, further comprising a processing element, wherein the wake-up module waking the processing element up to make the local server return to the normal operation mode, when the network packet received by the local host is a network wake-up packet.

17. The device of claim 9, wherein the format of the network packet and the network wake-up packet is based on IP.
